(19) United States
(12) Patent Application Publication
(10) Pub. No.: US 2025/0387736 A1
(43) Pub. Date: Dec. 25, 2025

(54) MODULAR CONNECTOR AND FILTRATION DEVICE WITH MODULAR CONNECTION FEATURES

(71) Applicant: EMD Millipore Corporation, Burlington, MA (US)

(72) Inventors: Kevin McDermot, Nashua, NH (US); Benjamin Cacace, Tewksbury, MA (US)

(21) Appl. No.: 19/236,362

(22) Filed: Jun. 12, 2025

Related U.S. Application Data
(60) Provisional application No. 63/661,799, filed on Jun. 19, 2024.

(51) Int. Cl. B01D 35/30; B01D 29/00; B01D 29/52; B01D 29/56; B01D 29/96

(52) U.S. Cl. CPC B01D 35/30; B01D 29/0093; B01D 29/52; B01D 29/56; B01D 29/96; B01D 2201/16; B01D 2201/182

(57) ABSTRACT

A modular connector for filtration devices is provided, where each modular connector includes a T-junction, sterile connectors, and a valve. The modular connector may be attached to ports of a filtration device and are configured to be coupled to other identical modular connectors of other filtration devices to facilitate the assembly of a modular manifold assembly that is more compact and has a smaller footprint than convention manifold assemblies. The valves of the modular connectors may be utilized, once the filtration devices are coupled to one another via the modular connectors, to direct a flow path in parallel through the filtration devices or in series through the filtration devices. The modular connectors may further facilitate the connection of any number of filtration devices to create a modular manifold assembly.

### CROSS-REFERENCE TO RELATED APPLICATIONS

This present application claims priority to U.S. Provisional Patent Application Ser. No. 63/661,799, entitled “MODULAR CONNECTOR AND FILTRATION DEVICE WITH MODULAR CONNECTION FEATURES,” and filed on Jun. 19, 2024, the disclosure of which is incorporated herein by reference in its entirety for all purposes.

### TECHNICAL FIELD

Embodiments of the technologies disclosed herein relate to filtration devices with modular connection features that enable filtration devices to be connected to one another to achieve a desired manifold design, and, particularly, a modular connector that facilitates the modular connection of multiple filtration devices.

### BACKGROUND OF THE INVENTION/DESCRIPTION OF RELATED ART

Filtration operations are performed in the downstream processing of biological feed streams used in the production of therapeutic biopharmaceuticals. In these operations, it is often necessary to increase the filtration area of filtration devices such as depth filters, membrane adsorbers, or virus filters in order to filter large volumes of these feed streams at the production scale. To achieve this, bioprocessing devices for filtration or purification are often manifolded to increase the effective filter area or membrane area while maintaining the modularity of each device. Examples of such bioprocessing devices are depth filters, pod depth filters, tangential flow filtration (TFF) devices or capsules, and anion exchange membrane devices. These bioprocessing devices may be modular and may have sterile connectors, which can be connected to previously arranged and built external manifold tube sets. Manifolding of multiple bioprocessing devices is currently accomplished through the use of symmetric/bifurcation splitting or U-type/Z-type splitting configurations. Efficient flow distribution through these pre-built manifolds is required for the efficient performance of assemblies of downstream bioprocessing devices. Traditionally, the pre-built manifolds used for connecting multiple devices include one trunk tubing with several branches connecting multiple bioprocessing devices in a parallel manner. However, this requires a large number of connectors, a large amount of tubing, and consumes a large area of a production floor (i.e., the pre-built manifolds have a large footprint). Moreover, once built, these manifolds are not easily reconfigurable.

In addition, in many cases, pre-use flushing is currently performed using water or a buffer solution (flushing or non-clogging feed stream) prior to flowing a fouling (clogging feed stream) feed stream through the bioprocessing devices. Even with a naturally balanced or bifurcation splitting manifold configuration, if the flow resistance (or permeability) of one bioprocessing device is significantly different from the rest of the bioprocessing devices attached to the manifold, it is hard to achieve a uniform flow distribution across the bioprocessing devices, at least when running a flushing feed stream through the bioprocessing devices in parallel. This variation of flow resistance can come from lot-to-lot variations in filter media permeability. A non-uniform flow distribution may result in uneven flushing. More specifically, one or more of the manifolded bioprocessing devices may be under flushed, leading to the elevation of the total organic carbon extractables level in the effluent feed stream in the subsequent process.

Therefore, what is needed is a modular connector or a bioprocessing device equipped with modular connectors that are capable of being attached to other identical modular connectors to facilitate the creation of a modular manifold assembly for a plurality of the bioprocessing devices. What is further needed are sterile connectors on the modular connector to maintain the sterility of the bioprocessing device, as well as a dripless disconnect that allows for the bioprocessing devices to be self-containing when disassembling a manifold assembly. What is needed even further is the modular connector being equipped with a valve that allows for a user to independently select the ends of the modular connector through which a fluid may flow. Thus, disclosed herein is a modular connector for bioprocessing devices that facilitates a more customizable and compact manifold assembly capable of operating with a parallel flow path or a series flow path via the valves of the modular connector.

### SUMMARY OF THE INVENTION

Embodiments described herein are, e.g., modular connectors for filtration devices, and filtration devices equipped with the modular connectors. Each modular connector may include, among other features and structures, a T-junction, sterile connectors, and a valve. The modular connector may be attached to ports of a filtration device and are configured to be coupled to other identical modular connectors of other filtration devices to facilitate the assembly of a modular manifold assembly that is more compact and has a smaller footprint than convention manifold assemblies. The modular connectors also reduce the amount of tubing that is utilized for creating a manifold assembly without introducing additional sterile connectors. The valves of the modular connectors may be utilized, once the filtration devices are coupled to one another via the modular connectors, to direct a flow path in parallel through the filtration devices or in series through the filtration devices. The modular connectors may further facilitate the connection of any number of filtration devices in order to create a modular manifold assembly.

In an embodiment, a filtration device may include a housing, a filter media, a plurality of ports, and a modular connector. The housing may define an interior in which the filter media may be disposed. The plurality of ports may be disposed on the housing and configured to facilitate a flow of a fluid into and out of the housing. The modular connector may be coupled to each of the plurality of ports. Moreover, the modular connector may include a first connector end and a second connector end. The first connector end of each modular connector may be configured to be coupled to a second connector end of a modular connector of each of a plurality of ports of a secondary filtration device and the second connector end of the modular connector of each of the plurality of ports of the filtration device is configured to be coupled to a first connector of a tertiary filtration device to facilitate assembly of a modular flow manifold for the filtration device.

In some instances, the modular connectors may further include a T-junction having a first end, a second end, and a third end. The first end of the T-junction may serve as the first connector end of the modular connector. The second end of the T-junction may serve as the second connector end of the modular connector. The third end of the T-junction may be coupled to one port of the plurality of ports of the filtration device. In some further instances, the modular connector may further include a valve operatively coupled to the T-junction. The valve may be configured to selectively open and close each of the first end, the second end, and the third end of the T-junction. In some additional instances, the modular flow manifold can operate with both a parallel flow path and a series flow path depending on a setting of the valve. In the parallel flow path, the flow of the fluid flows through the filtration device, the secondary filtration device, and the tertiary filtration device in parallel. In the series flow path, the flow of the fluid flows through the filtration device, the secondary filtration device, and the tertiary filtration device in series. In some other instances, the modular connector may include a dripless disconnect disposed within the T-junction proximate to the second end of the T-junction.

In even some further instances, the modular connector may further include a first sterile connector and a second sterile connector. The first sterile connector may be disposed on the first connector end of the modular connector. The second sterile connector may be disposed on the second connector end of the modular connector. In yet some additional instances, the plurality of ports includes at least an inlet port, an outlet port, and a vent port.

In another embodiment, a method of assembling and operating a modular flow manifold may include equipping a plurality of filtration devices with modular connectors, coupling a first filtration device with a second filtration device, and setting a valve of each of the modular connectors to facilitate a parallel flow through the modular flow manifold. Each modular connector of each filtration device includes a first connector end and a second connector end. When coupling a first filtration device to a second filtration device, the second connector ends of the modular connectors of the first filtration device are coupled to the first connector ends of the modular connectors of the second filtration device. When the modular flow manifold is configured for the parallel flow, a fluid flows simultaneously through the first and second filtration devices.

In some instances, the first ends of the modular connectors of the first filtration device serve as the inlet and outlet of the modular flow manifold. In some further instances, the valves of the modular connectors of the second filtration device are set such that the fluid cannot flow through the second ends of modular connectors of the second filtration device. In some other instances, the method may further include coupling a third filtration device to the second filtration device by coupling the first connector ends of the modular connectors of the third filtration device to the second connector ends of the modular connectors of the second filtration device.

In some additional instances, the fluid may be a second fluid, and the method may further include, prior to setting the valve of each of the modular connectors of the modular flow manifold to the parallel flow, setting the valve of each of the modular connectors to facilitate a series flow through the modular flow manifold where a first fluid flows first through the first filtration device and then through the second filtration. In some even further instances, the first fluid is a flushing feed stream and the second fluid is a fouling feed stream.

In yet another embodiment, a modular connector for a filtration device includes a T-junction, a valve, a first sterile connector, and a second sterile connector. The T-junction may include a first end, a second end, and a third end. The third end may be coupled to a port of the filtration device. The valve may be disposed in the T-junction and may be configured to selectively and independently open and close the first end, the second end, and the third end of the T-junction. The first sterile connector may be coupled to the first end of the T-junction. The second sterile connector may be coupled to the second end of the T-junction. The first sterile connector may be configured to be coupled to a second sterile connector of a second modular connector attached to a second filtration device, and the second sterile connector is configured to be coupled to a first sterile connector of a third modular connector attached to a third filtration device.

In some instances, when attached to the filtration device, at least a portion of the T-junction is configured to rotate about an axis passing through the third end of the T-junction. In some other instances, the modular connector may further include a dripless disconnect disposed proximate to the second end of the T-junction. In some additional instances, the breathable microbial barrier may include an elasticized band that enables the breathable microbial barrier to be disposed over the port of the tubing arrangement. In some further instances, the modular connector may further include a first conduit having a first end and an opposite second end. The first end of the first conduit may be directly coupled to the port of the filtration device. The second end of the first conduit may be directly coupled to the third end of the T-junction. In some even further instances, the modular connector may also include a second conduit having a first end and an opposite second end. The first end of the second conduit may be directly coupled to the second end of the T-junction. The second end of the second conduit may be directly coupled to the second sterile connector.

### BRIEF DESCRIPTION OF THE DRAWINGS

The apparatuses, systems, devices, manifolds, filtration devices or PODs, modules, components, connectors, couplers, etc., presented herein may be better understood with reference to the following drawings and description. It should be understood that some elements in the figures may not necessarily be to scale and that emphasis has been placed upon illustrating the principles disclosed herein. In the figures, like-referenced numerals designate corresponding parts/steps throughout the different views.

FIG. 1 illustrates a perspective view of a depth filtration device, according to an example embodiment.

FIGS. 2A and 2B illustrate partial cross-sectional views of the depth filtration device shown in FIG. 1 and showing the flow path of fluid through the depth filtration device in accordance with an example embodiment.

FIG. 3 illustrates a schematic diagram of a filtration device, similar to that shown in FIG. 1, equipped with modular connectors coupled to the inlet, outlet, and vent ports in accordance with the present invention.

FIG. 4 illustrates another schematic diagram of a filtration device, similar to that shown in FIG. 1, being equipped with modular connectors coupled to the inlet and outlet in accordance with the present invention.

FIGS. 5A-5E illustrate detailed schematic illustrations of the modular connectors of the filtration device illustrated in FIG. 4 in accordance with the present invention, and where the modular connectors are set to different operational states.

FIG. 6A-6C illustrate detailed schematic illustrations of the modular connectors of FIG. 5A being coupled to one another and the various flow configurations in accordance with the present invention.

FIG. 7 illustrates a schematic diagram of several of the depth filtration devices shown in FIG. 4 coupled to one another in order to create a manifold assembly in which a fluid flowing through the manifold passes through the modular depth filtration devices in parallel and in accordance with the present invention.

FIG. 8 illustrates a schematic diagram of several of the depth filtration devices shown in FIG. 4 coupled to one another in order to create a manifold assembly in which a fluid flowing through the manifold assembly passes through the modular depth filtration devices in series and in accordance with the present invention.

### DETAILED DESCRIPTION

Aspects of the disclosure are disclosed in the description herein. Alternate embodiments of the present disclosure and their equivalents may be devised without parting from the spirit or scope of the present disclosure. It should be noted that any discussion herein regarding “one embodiment,” “an embodiment,” “an exemplary embodiment,” and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of a given embodiment may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

Although specific terms are used in the following description for the sake of clarity, these terms are intended to refer only to the particular structure of the embodiments selected for illustration in the drawings. In the drawings and the following description below, it is to be understood that like numeric designations refer to components of like function.

The singular forms “a,” “an,” and “the” include plural referents unless the context clearly dictates otherwise.

As used in the specification, various devices and parts may be described as “comprising” other components. The terms “comprise(s),” “include(s),” “having,” “has,” “can,” “contain(s),” and variants thereof, as used herein, are intended to be open-ended transitional phrases, terms, or words that do not preclude the possibility of additional components.

All ranges disclosed herein are inclusive of the recited endpoint and independently combinable (for example, the range of “from 2% to 10%” is inclusive of the endpoints, 2% and 10%, and all the intermediate values).

As used herein, approximating language may be applied to modify any quantitative representation that may vary without resulting in a change in the basic function to which it is related. Accordingly, a value modified by a term or terms, such as “about,” “approximately,” and “substantially,” may not be limited to the precise value specified, in some cases. The modifiers should also be considered as disclosing the range defined by the absolute values of the two endpoints. For example, the expression “from about 2 to about 4” also discloses the range “from 2 to 4.”

It should be noted that some terms used herein are relative terms. For example, the terms “upper” and “lower” are relative to each other in location, i.e., an upper component is located at a higher elevation than a lower component and should not be construed as requiring a particular orientation or location of the structure. As a further example, the terms “interior,” “exterior,” “inward,” and “outward” are relative to a center, and should not be construed as requiring a particular orientation or location of the structure.

The terms “top” and “bottom” are relative to an absolute reference, i.e., the surface of the earth. Put another way, a top location is always located at a higher elevation than a bottom location, toward the surface of the earth.

The terms “sterilization,” “sterilized,” and “sterile,” typically refer to sterilization processes or conditions that result in a sterility assurance level (SAL) of 10⁻⁶, which represents a 1 in 1,000,000 chance of a non-sterile unit. For the purposes of the present disclosure, these terms shall also comprise sub-sterilization processes and conditions where 10⁻⁶ SAL sterility is not achieved, which may sometimes be denoted using higher SALs (e.g., 10⁻⁵, 10⁻⁴, 10⁻³, etc.) and/or other terms like “bioburden reduction,” “bioburden-reduced,” “sanitization,” and/or “sanitary.”

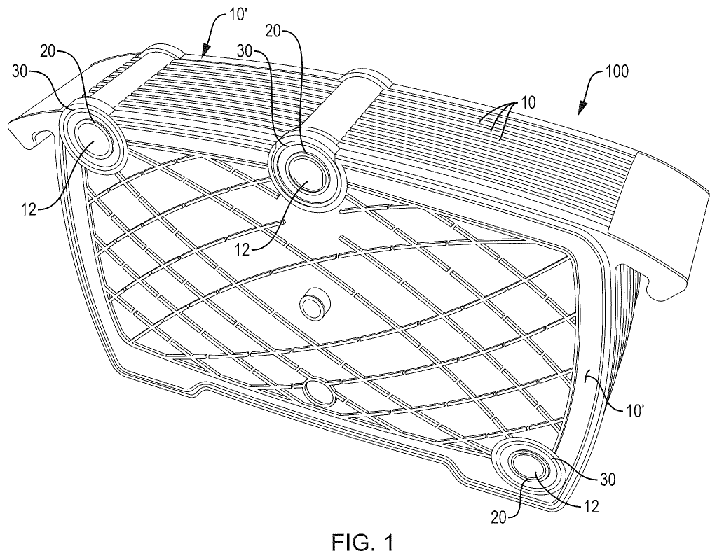

Turning now to FIG. 1, illustrated is an example embodiment of a filtration device 100 in accordance with certain embodiments. The filtration device 100 illustrated in FIG. 1 is an example of a depth filtration device. However, the principles and features described herein, particularly with regard to the modular connections described in further detail below, may be applied to any bioprocessing device including, but not limited to, depth filters, pod depth filters, TFF devices or capsules, anion exchange membrane devices, etc. The filtration device 100 may be an assembly of a plurality of rigid filter packets 10, each of which includes one or more fluid ports 12 that provides fluid communication to one or more fluid channels formed in each packet 10. In the embodiment shown, there are ten such packets 10, but fewer or more could be used to form a filtration device 100. The filtration device 100 also includes two opposite rigid endcaps 10′ that together sandwich the packets 10 between them. The packets 10 and the endcaps 10′, and subsequently the filtration device 100, may be disposable single-use devices. Thus, the packets 10 and the endcaps 10′ may be made of a suitable material that is sterilizable, such plastic, polycarbonate, or a polyolefin such as polypropylene.

In certain embodiments, a plurality of individual packets 10 may be stacked together to form the filtration device 100 and may be interconnected with one another to provide fluid communication between them through their respective fluid ports 12 such that the packets 10 operate with one another to facilitate a parallel filtration operation. In certain embodiments, one of the fluid ports 12 may be an inlet port for the introduction of a liquid sample into the filtration device 100, one or more fluid ports 12 may be an outlet port for removal of a liquid sample from the filtration device 100, and one or more fluid ports 12 may be a vent port for venting gas, such as air, from the filtration device 100.

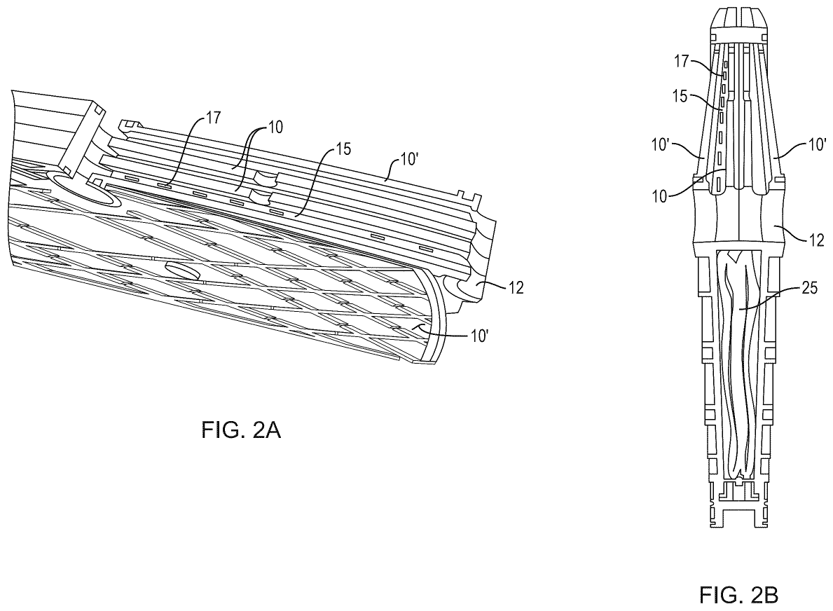

One or more of the filter packets 10 may contain media, such as media suitable for depth filtration, tangential flow filtration, cross-flow filtration, etc. Exemplary depth filtration media includes diatomaceous earth, cellulose, activated carbon, polyacrylic fiber and silica. One or more of the filter packets 10 may include one or more membranes, such as a stack of membranes. One possible fluid flow path through a filtration device 100 is shown in FIGS. 2A and 2B. In the embodiment shown, fluid may enter an inlet fluid port 12, flow into a channel 15 formed across the packet body, and then flow downward through small slits 17 formed in the channel 15 to the upstream side of the media or membrane(s) 25. The fluid may then flow through the media or membrane(s) 25, and enter similar slits positioned in a channel at a downstream side of the media or membrane(s) 25. The fluid may then flow out the outlet fluid port 12. Disposed around each of the fluid ports 12 may be one or more seals 20, 30.

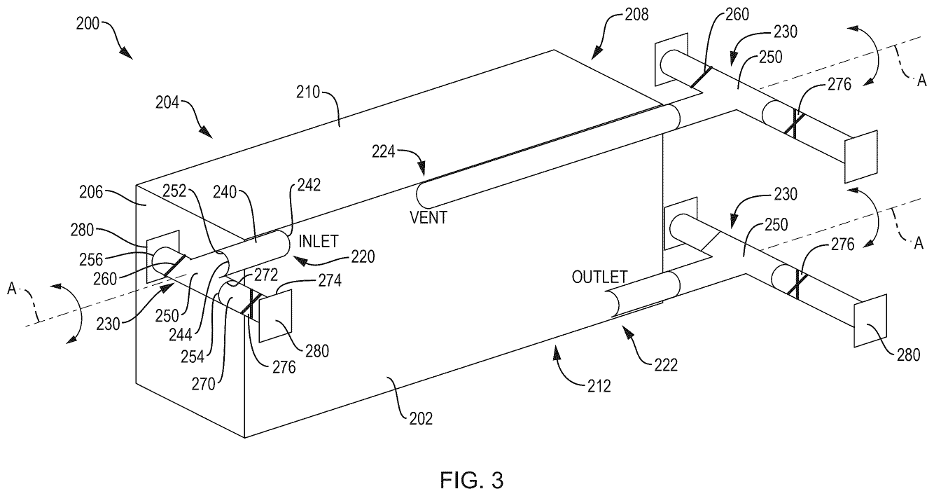

Turning to FIG. 3, illustrated is a schematic drawing of a filtration device 200, which may be similar to the filtration device 100 illustrated in FIGS. 1, 2A, and 2B. Thus, the filtration device 200 may be made of a suitable material that is sterilizable, and may contain media, such as media suitable for depth filtration, tangential flow filtration, cross-flow filtration, etc. As illustrated in FIG. 3, the filtration device 200 may include a first side 202, an opposite second side 204, a first end 206 spanning between the first and second sides 202, 204, and a second end 208 opposite the first end 206 and spanning between the first and second sides 202, 204. The filtration device 200 may generally also include a top side 210 and an opposite bottom side 212, where both the top and bottom sides 210, 212 span between the first side 202, the second side 204, the first end 206, and the second end 208.

The filtration device 200 further includes an inlet port 220, an outlet port 222, and a vent port 224 that are all disposed on the first side 202 of the filtration device 200. The inlet port 220 may be disposed on the first side 202 of the filtration device 200 proximate to the first end 206 and the top side 210. The outlet port 222 may be disposed on the first side 202 of the filtration device 200 proximate to the second end 208 and the bottom side 212. The vent port 224 may be disposed on the first side 202 of the filtration devices 200 proximate to the top side 210 and equidistant from the first and second ends 206, 208. In other embodiments, the ports 220, 222, 224 may be disposed in any location on the first side 202 or any location on any other side 204, 210, 212 and/or end 206, 208 of the filtration device 200. In the embodiment shown, fluid may enter the inlet port 220, flow through the media or membrane(s) disposed within the filtration device 200 (not shown), and then flow out the outlet fluid port 222 while the vent port 224 vents gas, such as air, from the filtration device 200.

As further illustrated in FIG. 3, coupled to each of the ports 220, 222, 224 is a modular connection 230. Each modular connection 230 may include a first conduit 240, T-junction 250 that may be rotatable about axis A, a valve 260, a second conduit 270, and a pair of sterile connectors 280. The first conduit 240 may include a first end 242, which is coupled to a port 220, 222, 224, and an opposite second end 244. The T-junction 250 may be in the shape of a “T”, and may have a first end 252, a second end 254, and a third end 256. The portion of the T-junction forming the second and third ends 254, 256 may be aligned linearly (such that a linear axis along which they are aligned bisects the axis A), while the portion of the T-junction 250 forming the first end 252 may bisect the linearly aligned portions of the second and third ends 254, 256. The first end 252 of the T-junction 250 may be coupled to the second end of the first conduit 240. In the embodiment illustrated, the T-junction 250 may be configured to rotate about axis A, which is coaxial with the portion of the T-junction 250 forming the first end 252. In other embodiments, the T-junction 250 may be configured to rotate about other axes or may not be capable of rotation.

Moreover, a valve 260 may be disposed in the T-junction 250 proximate to or within the section of the T-junction 250 that serves as the intersections of each of the portions forming the first end 252, second end 254, and third end 256 of the T-junction 250. The valve 260 may be any type of valve suitable to control fluid flow into and through the T-junction 250, including selectively and independently controlling fluid flow through the desired ends 252, 254, 256 of the T-junction 250. Moreover, the valve 260 may be any type of valve including, but not limited to, a stopcock. A second conduit 270 may be coupled to the second end 254 of the T-junction 250. More specifically, the second conduit 270 may include a first end 272, which is coupled to the second end 254 of the T-junction 250, and an opposite second end 274. As further illustrated in FIG. 3, a dripless disconnect 276 may be disposed within the second conduit 270 between the first and second ends 272, 274, where the dripless disconnect 276 enables the filtration device 200 equipped with the modular connection 230 to be completely self-containing when disassembling the filtration device 200 from other filtration devices 200 after multiple filtration devices 200 have been assembled into a modular flow manifold (as explained in further detail below). As further illustrated in FIG. 3, each modular connection 230 further includes sterile connectors 280. One sterile connector 280 may be coupled to the third end 256 of the T-junction 250, while the other sterile connector 280 may be coupled to the second end 274 of the second conduit 270. The sterile connectors 280 may be utilized to ensure that each filtration device 200 equipped with the modular connectors 230 remain completely sterile prior to, and during, the combining of the filtration devices 200 together into a modular manifold. As further explained below, a plurality of the filtration devices 200 may be combined with one another, via the modular connectors 230, to create a modular flow manifold that is more compact and has a reduced footprint compared to that of traditional flow manifolds for filtration devices.

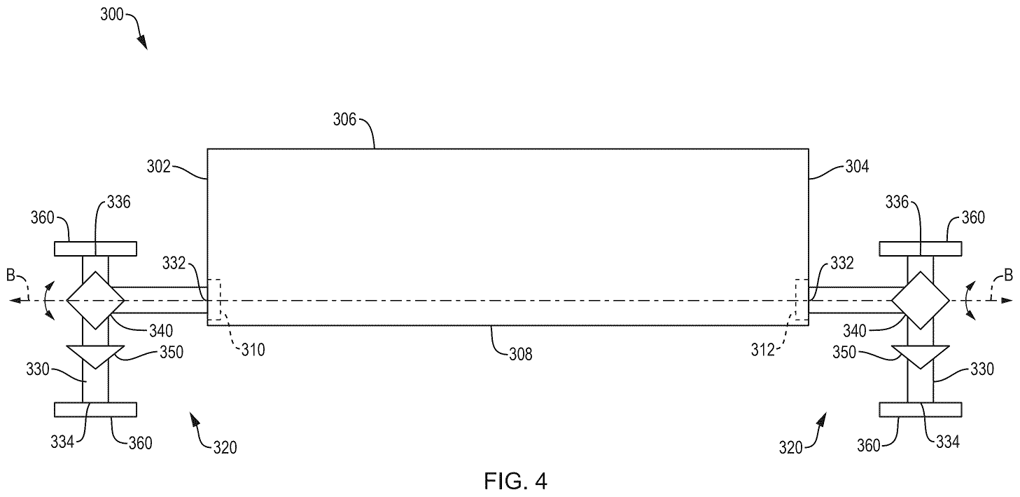

Turning to FIG. 4, illustrated is another schematic illustration of an embodiment of a filtration device 300 equipped with modular connectors 320 like that of the embodiment of the filtration device 200 illustrated in FIG. 3 except that the filtration device 300 is shown without a vent port and a modular connector 320 coupled to the vent port for illustrative purposes only. Thus, as illustrated, the filtration device 300 may include a first end 302, an opposite second end 304, a top side 306 spanning between the first end 302 and the second end 304, and a bottom side 308 opposite the top side 306 and also spanning between the first end 302 and the second end 304. The filtration device 300 may be made of a suitable material that is sterilizable. The ends 302, 304 and sides 306, 308 may collectively define an interior configured to house a filter media. More specifically, the filtration device 300 may contain media, such as media suitable for depth filtration, tangential flow filtration, cross-flow filtration, etc.

The filtration device 300 may further includes an inlet port 310 and an outlet port 312. While not illustrated, the filtration device 300 may also include a vent port. The inlet port 310 may be disposed proximate to or on the first end 302 of the filtration device 300, while the outlet port 312 may be disposed proximate to or on the opposite second end 304 of the filtration device 300. In other embodiments, the ports 310, 312 may be disposed in any location on the filtration device 300. In the embodiment shown, fluid may enter the inlet port 310, flow through the media or membrane(s) (not shown) disposed within the filtration device 300, and then flow out the outlet fluid port 312 while the vent port vents gas, such as air, from the filtration device 300.

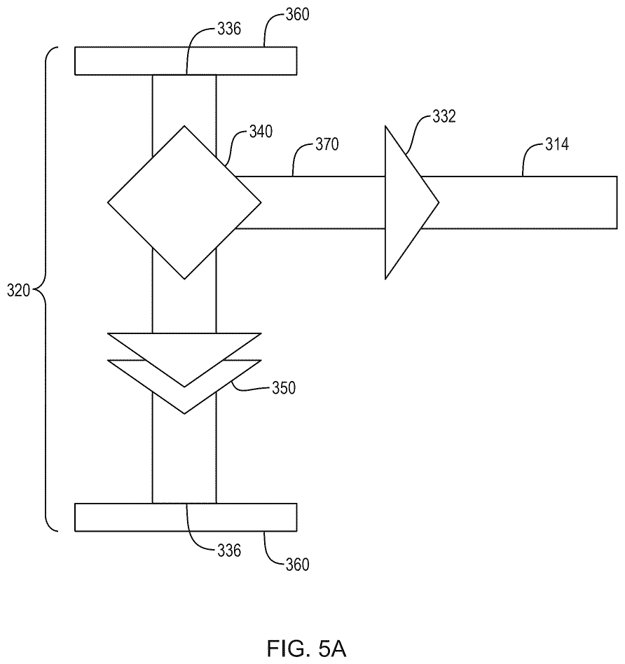

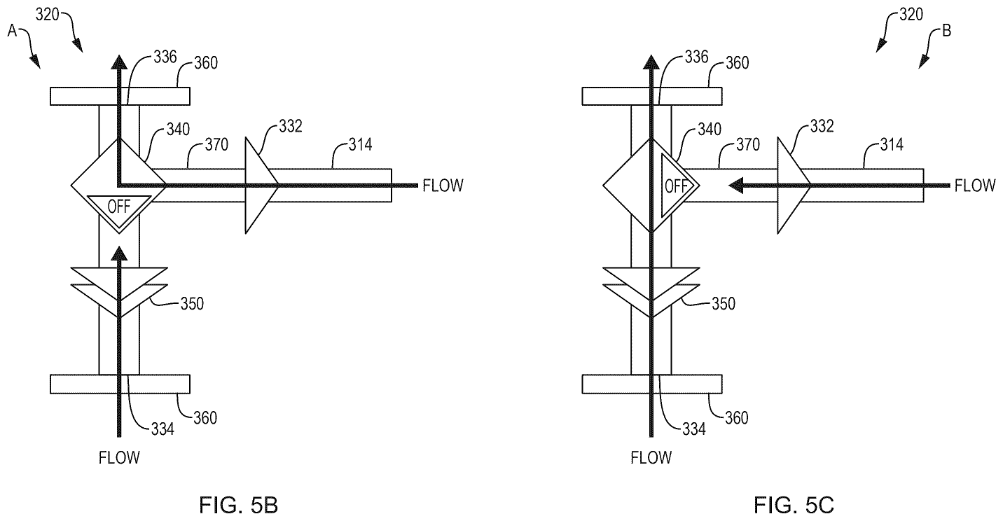

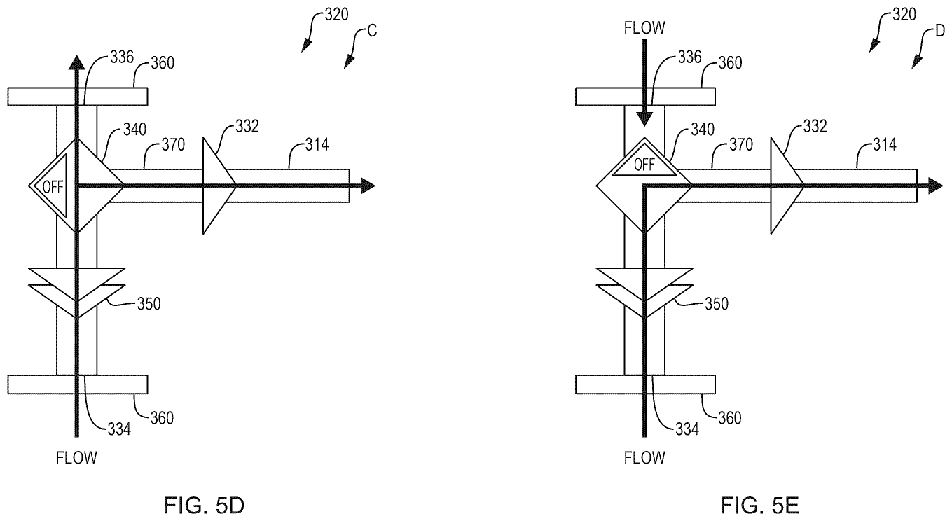

As further illustrated in FIG. 4, coupled to each of the ports 310, 312 is a modular connector or modular connection 320, which is shown in isolation in FIGS. 5A-5E. Each modular connection 320 may include a T-junction 330 that may be rotatable about axis B, a valve 340, a dripless disconnect 350, and a pair of sterile connectors 360. The T-junction 330 may be in the shape of a “T”, and may have a first end 332, a second end 334, and a third end 336. The portion of the T-junction forming the second and third ends 334, 336 may be aligned linearly (along an axis that may bisect the axis B), while the portion of the T-junction 330 forming the first end 332 may bisect the linearly aligned portions of the second and third ends 334, 336. In some embodiments, the portion of the T-junction 330 forming the first end 332 may be in the form of a rotatable hose barb 370 (best shown in FIGS. 5A-5E), which allows the modular connection The first end 332 of the T-junction 330 may be coupled to the ports 310, 312 of the filtration device 300. In the embodiment illustrated, the T-junction 330 may be configured to rotate about axis B (i.e., the rotatable hose barb 370), which is coaxial with the portion of the T-junction 330 forming the first end 332. In other embodiments, the T-junction 330 may be configured to rotate about other axes or may not be capable of any rotation.

Moreover, a valve 340 may be disposed within the T-junction 330 proximate to or within the section of the T-junction 330 that serves as the intersections of each of the portions forming the first end 332, second end 334, and third end 336 of the T-junction 330. The valve 340 may be any type of valve suitable to control fluid flow into and through the T-junction 330, including selectively and independently controlling fluid flow through the desired ends 332, 334, 336 of the T-junction 330 like that illustrated in FIGS. 5B-5E. Thus, the valve 340 may be any type of valve including, but not limited to, a stopcock. As illustrated in FIG. 5B, the valve 340 may be rotated to place the modular connection 320 in a first operation state A. In this first operational state A, a fluid flowing into the modular connection 320 via the second end 334 may not pass through the valve 340 and the rest of the modular connection 320, but a fluid flowing into the modular connection 320 via the first end 332 may pass through the valve 340 and out of the third end 336 of the modular connection 320 (or vice versa). As illustrated in FIG. 5C, the valve 340 may also be rotated to a position that places the modular connection 320 in a second operational state B. In this second operational state B, a fluid flowing into the modular connection 320 via the second end 334 may pass through the valve 340 and out of the third end 336 of the modular connection 320 (or vice versa). However, a fluid flowing into the modular connection 320 via the first end 332 may be prevented from flowing through the rest of the modular connection 320 as the fluid may not pass the valve 340. As further illustrated in FIG. 5D, the valve 340 may be rotated to a third position that places the modular connection 320 in a third operational state C. In this third operational state C, the valve 340 has opened all of the pathways through the modular connection 320. Thus, while FIG. 5D illustrates a fluid flowing into the second end 334 of the modular connection 320 and out of both the first end 332 and the third end 336 of the modular connection 320, when in the third operational state C, a fluid may flow into the modular connection 320 via any end 332, 334, 336 and out of any of the other two remaining ends 332, 334, 336 of the modular connection 320. Finally, as best illustrated in FIG. 5E, the valve 340 may be rotated to a fourth position that places the modular connection 320 in a fourth operational state D. In this fourth operational state D, a fluid flowing into the modular connection 320 via the second end 334 may pass through the valve 340 and out of the first end 332 of the modular connection 320 (or vice versa). However, a fluid flowing into the modular connection 320 via the third end 336 may be prevented from flowing through the rest of the modular connection 320 as the fluid may not pass the valve 340.

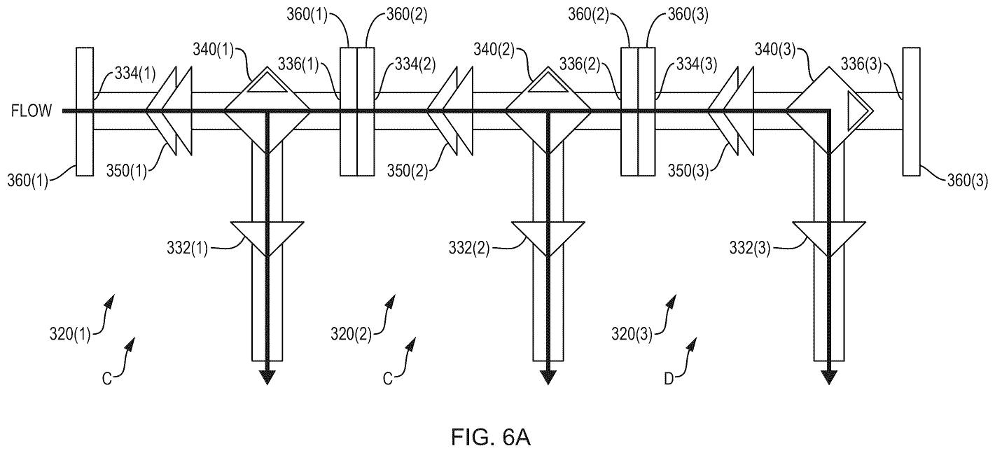

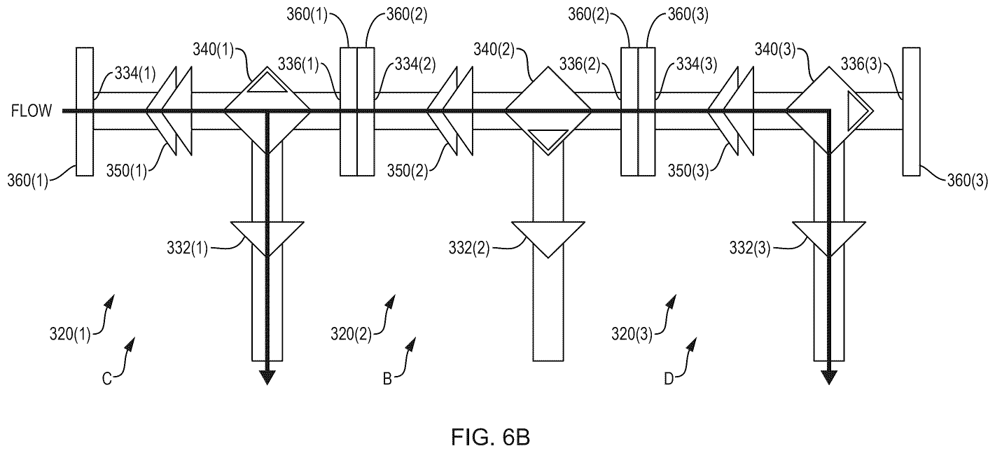

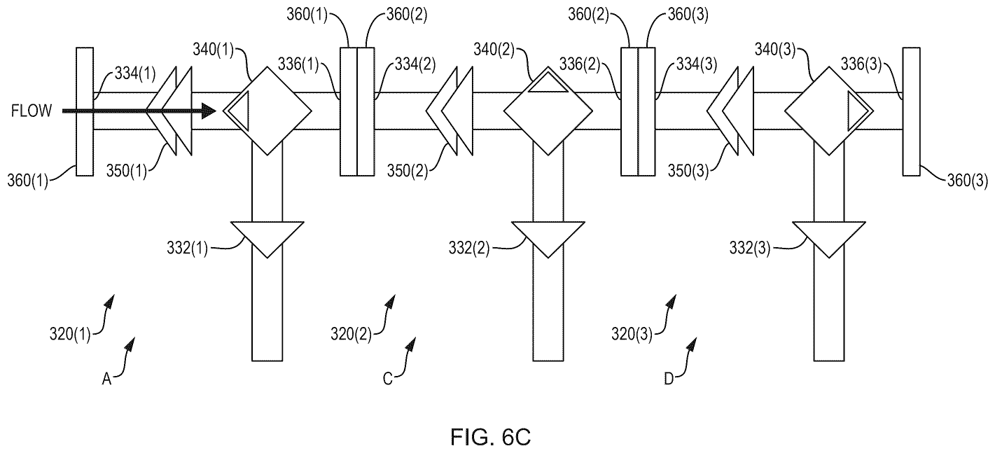

Returning to FIGS. 4 and 5A, a dripless disconnect 350 may be disposed within the portion of the T-junction 330 that forms the second end 334 of the T-junction 330 (i.e., between the intersection of the other portions of the T-junction 330 and the second end 334 of the T-junction 330), where the dripless disconnect 350 enables the filtration device 300 equipped with the modular connections 320 to be completely self-containing when disassembling the filtration device 300 from other filtration devices 300 after multiple filtration devices 300 have been assembled with one another into a modular flow manifold (as explained in further detail below). As further illustrated in FIGS. 4 and 5A, each modular connection 320 further includes a pair of sterile connectors 360. A sterile connector 360 may be coupled to the each of the second and third ends 334, 336 of the T-junction 330. The sterile connectors 360 may be utilized to ensure that each filtration device 300 equipped with the modular connections 320 remain completely sterile prior to, and during, the combining of the filtration devices 300 together (as illustrated in FIGS. 6A-6C, 7, and 8 described in further detail below) into a modular flow manifold. The dripless disconnect 350 may be configured to provide free rotation of 360 degrees, which may allow the sterile connectors 360 to properly spin and align with sterile connectors 360 of another modular connection 360 for proper coupling to one another. As further explained below, a plurality of the filtration devices 300 may be combined with one another, via the modular connections 320, to create a modular flow manifold that is more compact and has a reduced footprint compared to that of traditional manifolds for filtration devices.

The modular connection 320, as depicted in FIGS. 4 and 5A-5E may be a single molded component that incorporates all of the features including, but not limited to, the reconfigurable valve 340, the dripless disconnect 350, the sterile connectors 360, and the rotatable hose barb 370. The modular connections 320 may be molded using a combination of injection molding and plastic welding techniques such as, but not limited to, spin welding, vibration welding, and solvent welding. As further illustrated in FIGS. 5A-5E, the modular connections 320 may include a tubing element 314 that connects or couples the first end 332 of the modular connection 320 to the filter device 300 (i.e., to the ports 310, 312).

Turning to FIGS. 6A-6C, and with continued reference to FIGS. 4 and 5A-5E, illustrated are three modular connectors 320(1)-320(3) connected to one another to demonstrate three example embodiments of various flow paths that may be achieved with the modular connector 320 disclosed herein. As illustrated in FIGS. 6A-6C, the third end 336(1) of the first modular connector 320(1) is coupled to the second end 334(2) of the second modular connector 320(2), while the second end 334(3) of the third modular connector 320(3) is coupled to the third end 336(2) of the second modular connector 320(2). More specifically, the sterile connector 360(1) of the third end 336(1) of the first modular connector 320(1) is coupled to sterile connector 360(2) of the second end 334(2) of the second modular connector 320(2). Furthermore, the sterile connector 360(3) of the second end 334(3) of the third modular connector 320(3) is coupled to sterile connector 360(2) of the third end 336(2) of the second modular connector 320(2). While not illustrated, the first ends 332(1)-332(3) of the modular connectors 320(1)-320(3), respectively, may be coupled to respective filtration devices 300(1)-300(3).

In the example arrangement illustrated in FIG. 6A, the first and second modular connectors 320(1), 320(2) are in the third operational state C (as shown in FIG. 5D), while the third modular connector 320(3) is in the fourth operational state D (as shown in FIG. 5E). Thus, with the modular connectors 320(1)-320(3) being coupled to one another, a fluid flowing into the arrangement via the second end 334(1) of the first modular connector 320 is split to flow through the first end 332(1) of the first modular connector 320(1) to the respective filtration device 300(1) and through the third end 336(1) of the first modular connector 320(1) to the second modular connector 320(2). The fluid flows into the second modular connector 320(2) via the second end 334(2), where, because the second modular connector 320(2) is in the third operational state C, the fluid is split to flow through the first end 332(2) of the second modular connector 320(2) to the respective filtration device 300(2) and through the third end 336(2) of the second modular connector 320(2) to the third modular connector 320(3). With the third modular connector 320(3) in the fourth operational state D, the fluid flowing into the third modular connector 320(3) via the second end 334(3) is directed to flow out of the first end 332(3) of the third modular connector 320(3) to the respective filtration device 300(3) and is prevented from flowing out of the third modular connector 320(3) via the third end 336(3).

In the example arrangement illustrated in FIG. 6B, the first modular connector 320(1) is in the third operational state C (as shown in FIG. 5D), the second modular connector 320(2) is in the second operational state B (as shown in FIG. 5C), and the third modular connector 320(3) is in the fourth operational state D (as shown in FIG. 5E). Thus, with the modular connectors 320(1)-320(3) being coupled to one another, a fluid flowing into the arrangement via the second end 334(1) of the first modular connector 320 is split to flow through the first end 332(1) of the first modular connector 320(1) to the respective filtration device 300(1) and through the third end 336(1) of the first modular connector 320(1) to the second modular connector 320(2). The fluid flows into the second modular connector 320(2) via the second end 334(2), where, because the second modular connector 320(2) is in the second operational state B, the fluid flows through the third end 336(2) of the second modular connector 320(2) to the third modular connector 320(3) and is prevented from flowing through the first end 332(2) of the second modular connector 320(2) to the respective filtration device 300(2). With the third modular connector 320(3) in the fourth operational state D, the fluid flowing into the third modular connector 320(3) via the second end 334(3) is directed to flow out of the first end 332(3) of the third modular connector 320(3) to the respective filtration device 300(3) and is prevented from flowing out of the third modular connector 320(3) via the third end 336(3).

In the example arrangement illustrated in FIG. 6C, the first modular connector 320(1) is in the first operational state A (as shown in FIG. 5B), the second modular connector 320(2) is in the third operational state C (as shown in FIG. 5D), and the third modular connector 320(3) is in the fourth operational state D (as shown in FIG. 5E). A fluid flowing into the arrangement via the second end 334(1) of the first modular connector 320(1) is prevented from flowing any further through the arrangement because the first modular connector 320(1) is in the first operational state A. Thus, in the example arrangement of FIG. 6C, the fluid flowing through the second end 334(1) is prevented from flowing to either of the second or third modular connectors 320(2), 320(3), and is prevented from flowing to the respective filtration devices 300(1)-300(3).

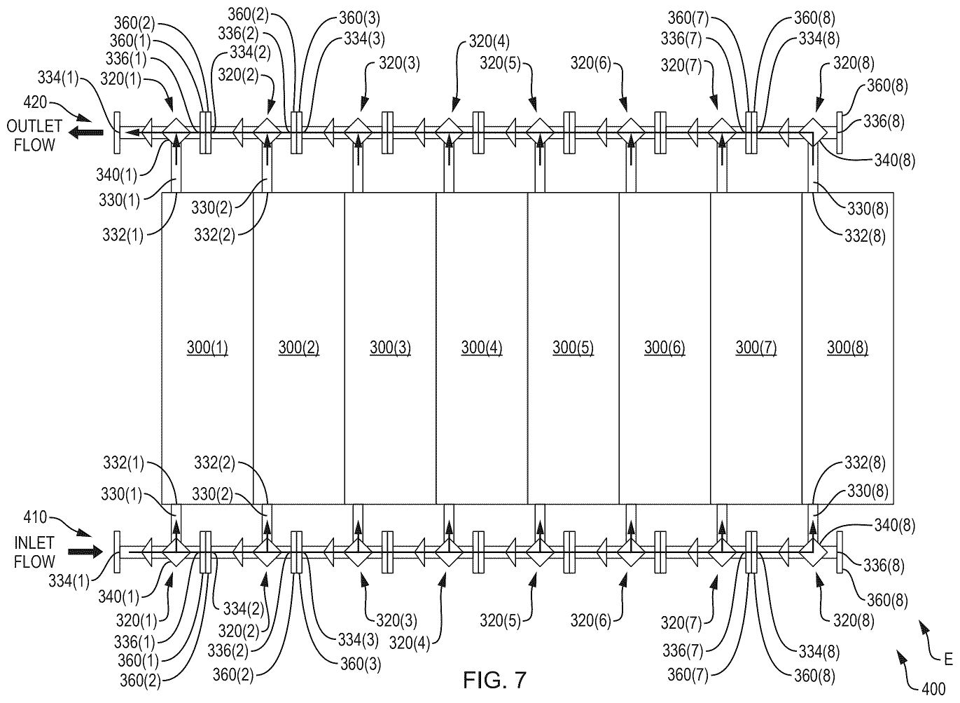

Turning to FIG. 7, and with continued reference to FIGS. 4, 5A-5E, and 6A-6C, illustrated is a parallel flow manifold 400 that is formed from an assembly of eight filtration devices 300(1)-300(8) equipped with modular connections 320 configured to couple to one another. In the illustrated embodiment of FIG. 7, the parallel flow manifold 400 may be configured to permit a fluid to flow through the flow manifold 400 in a U-shaped flow path E, where the fluid flows through each of the filtration devices 300(1)-300(8) in parallel. As illustrated in FIG. 7, the first and eighth filtration devices 300(1), 300(8) are coupled to only one other filtration device (the second and seventh filtration devices 300(2), 300(7), respectively), while the other filtration devices 300(2)-300(7) are each connected to two filtration devices 300(1)-300(8) (i.e., to a respective preceding filtration device 300(1)-300(6) and to a respective successive filtration device 300(3)-300(8)). More specifically, each of the filtration devices 300(1)-300(8) may be coupled to other respective filtration devices 300(1)-300(8) via the modular connections 320(1)-320(8). For example, the first filtration device 300(1) may be coupled to the second filtration device 300(2) via the modular connections 320(1), 320(2) and sterile connectors 360(1), 360(2), where the third end 336(1) of the T-junctions 330(1) of the modular connections 320(1) of the first filtration device 300(1) is coupled to the second end 334(2) of the T-junctions 330(2) of the modular connections 320(2) of the second filtration device 300(2). As another example, the eighth filtration device 300(8) may be coupled to the seventh filtration device 300(7) via the modular connections 320(7), 320(8) and sterile connectors 360(7), 360(8), where the third end 336(7) of the T-junctions 330(7) of the modular connections 320(7) of the seventh filtration device 300(7) is coupled to the second end 334(8) of the T-junctions 330(8) of the modular connections 320(8) of the eighth filtration device 300(8). As yet another example, the second filtration device 300(2) may be coupled to both the first filtration device 300(1) and the third filtration device 300(3) via the modular connections 320(1), 320(2), 320(3) and sterile connectors 360(1), 360(2), 360(3), where the third end 336(1) of the T-junctions 330(1) of the modular connections 320(1) of the first filtration device 300(1) is coupled to the second end 334(2) of the T-junctions 330(2) of the modular connections 320(2) of the second filtration device 300(2) and where the third end 336(2) of the T-junctions 330(2) of the modular connections 320(2) of the second filtration device 300(2) is coupled to the second end 334(3) of the T-junctions 330(3) of the modular connections 320(3) of the third filtration device 300(3). The third through seventh filtration devices 300(3)-300(7) may be similarly coupled to a preceding and successive filtration device 300(2)-300(8) via the modular connections 320(3)-300(7) like that of the second filtration device 300(2).

The valves 340(1)-340(7) may be rotated or set such that a fluid flowing through the modular connections 320(1)-320(7) may flow through each of the first ends 332(1)-332(7), the second ends 334(1)-334(7), and the third ends 336(1)-336(7) of the T-junctions 330(1)-330(7) of the modular connections 320(1)-320(7). In other words, the modular connections 320(1)-320(7) may be set to the third operational state C as illustrated in FIG. 5D. Furthermore, the valves 340(8) of the eighth modular connections 320(8) may be rotated or set such that a fluid may flow through each of the first ends 332(8) and the second ends 334(8) of the T-junctions 330(8) of the modular connections 320(8), but not through the third ends 336(8) of the T-junctions 330(8) of the modular connections 320(8). In other words, the modular connections 320(8) may be set to the third operational state D as illustrated in FIG. 5E. Thus, in this arrangement, the second end 334(1) of the T-junction 330(1) of one of the modular connection 320(1) (i.e., the lower modular connection 320(1) in FIG. 7) of the first filtration device 300(1) may serve as the inlet 410 of the parallel flow manifold 400, while the second end 334(1) of the T-junction 330(1) of the other modular connection 320(1) (i.e., the upper modular connection 320(1) in FIG. 7) of the filtration device 300(1) may serve as the outlet 420 of the parallel flow manifold 400. Moreover, the fluid entering the manifold 400 through the inlet 410 may flow into each of the modular connections 320(1)-320(8) on one side (i.e., the lower side in FIG. 7) of the filtration devices 300(1)-300(8) by flowing through the second ends 334(1)-334(8) of the T-junctions 330(1) of the modular connections 320(1)-320(8) and the third ends 334(1)-334(7) of the T-junctions 330(1)-330(7) of the modular connections 320(1)-320(7). With the setting of the valve 340(8) of the eighth modular connections 320(8) as explained above (i.e., the fourth operational state D), the fluid flowing into the lower eighth modular connection 320(8) would not flow out of the third end 336(8) of the T-junction 330(8) of the modular connection 320(8). The fluid flowing through the flow manifold 400 may then flow into each of the filtration devices 300(1)-300(8) simultaneously and in parallel by flowing through the respective first ends 332(1)-332(8) of the T-junctions 330(1)-330(8) of the modular connections 320(1)-320(8) (i.e., located on the lower side in FIG. 7).

After the fluid flows through each of the filtration devices 300(1)-300(8) in parallel, the fluid enters the modular connections 320(1)-320(8) located on the upper side of the filtration devices 300(1)-300(8) as depicted in FIG. 7. More specifically, the fluid exits the filtration devices 300(1)-300(8) and enters the respective modular connections 320(1)-320(8) via the first ends 332(1)-332(8) of the T-junctions 330(1)-330(8) of the modular connections 320(1)-320(8). The valves 340(1)-340(7) may be rotated or set to permit the fluid flowing through the parallel manifold 400 to flow through the second ends 334(1)-334(7) and third ends 336(1)-336(7) of the T-junctions 330(1)-330(7) of the modular connections 320(1)-320(7). In other words, the modular connections 320(1)-320(7) may be set to the third operational state C as illustrated in FIG. 5D. The valve 340(8) of the eighth modular connection 320(8) may be rotated or set to permit the fluid exiting the eighth filtration device 300(8) to flow through the first end 332(8) and the second end 334(8) of the T-junction 330(8) of the upper eighth modular connection 320(8), and preventing fluid from flowing out of the third end 336(8) of the T-junction 330(8) of the upper eighth modular connection 320(8). In other words, the modular connection 320(8) may be set to the fourth operational state D as illustrated in FIG. 5E. Thus, with the above described arrangement and valve 340(1)-340(8) settings, the parallel fluid streams exiting the filtration devices 300(1)-300(8) are intermixed with one another in the upper modular connections 320(1)-320(8) as shown in FIG. 7 before eventually flowing out of the outlet 420 of the parallel flow manifold 400, which is the second end 334(1) of the T-junction 330(1) of the modular connection 320(1) of the first filtration device 300(1).

The arrangement of the filtration devices 300(1)-300(8) depicted in FIG. 7 into a parallel flow manifold 400 may promote a flow path E, and may operate as a U-shaped manifold, where the inlet and outlet are located on the same side (i.e., the left side of the parallel flow manifold 400 depicted in FIG. 7) of the parallel flow manifold 400. However, the valve 340(1) of the upper modular connection 320(1) and the valve 340(8) of the upper modular connection 320(8) may be rotated or reset such that fluid flowing through the manifold 400 may not flow out of the second end 334(1) of the T-junction 330(1) of the upper modular connection 320(1), but is configured to flow out of the third end 336(8) of the T-junction 330(8) of the upper modular connection 320(8). In other words, the upper modular connection 320(1) may be changed from the third operational state C to the first operational state A, while the upper modular connections 320(8) may be changed from the fourth operation state D to the third operational state C. In this situation, the second end 334(1) of the T-junction 330(1) of the lower modular connection 320(1) still serves as the inlet 410 of the flow manifold 400, while the third end 336(8) of the T-junction 330(1) of the upper modular connection 320(1) now serves as the outlet 420 of the flow manifold 400. Thus, the flow manifold 400 still operates in parallel, where the fluid flows simultaneously and in parallel through the filtration devices 300(1)-300(8), but, instead of operating as a U-shaped manifold, the flow manifold 400 would then operate as a Z-shaped manifold (i.e., the inlet is located on the left side of the parallel flow manifold 400 depicted in FIG. 7, while the outlet is located on the right side of the parallel flow manifold 400 depicted in FIG. 7). In either operating manner (e.g., U-shaped or Z-shaped), a non-plugging or flushing feed stream may flow through the manifold 400 to flush the filtration devices 300(1)-300(8). In addition, in either operating manner (e.g., U-shaped or Z-shaped), a plugging or fouling feed stream may flow through the flow manifold 400 to be filtered by the filtration devices 300(1)-300(8).

The terms “left,” “right,” “lower,” and “upper” as recited above are merely for descriptive purposes of the arrangement shown in FIG. 7, and that the filtration devices 300(1)-300(8) and the modular connections 320(1)-320(8) may be disposed or arranged in any way such that the modular connections 320(1)-320(8) may be located on any side of the filtration devices 300(1)-300(8) and may be disposed with any physical spatial relation to the filtration devices 300(1)-300(8). Moreover, the number of filtration devices 300(1)-300(8) shown and depicted in FIG. 7 is for illustrative purposes only, and the modular connections 320(1)-320(2) enable any number N of filtration devices 300(1)-300(N) to be coupled to one another for form a flow manifold.

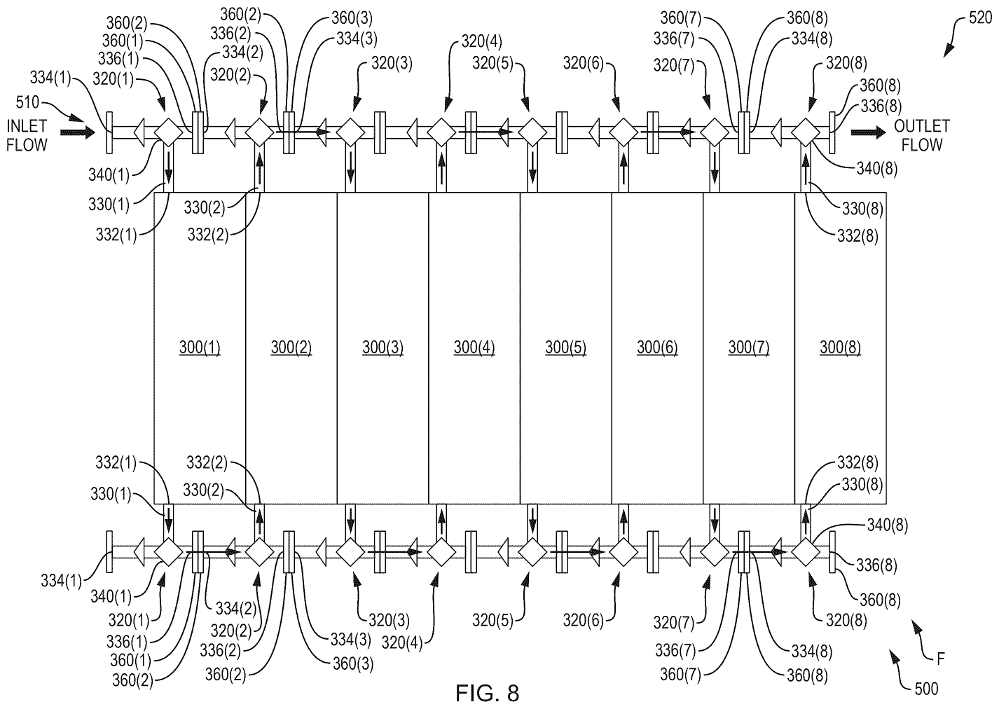

Turning to FIG. 8, and with continued reference to FIGS. 4, 5A-5E, 6A-6C, and 7, illustrated is a series flow manifold 500 that is formed from an assembly of eight filtration devices 300(1)-300(8) equipped with modular connections 320 configured to couple to one another in a similar manner to that described with the parallel flow manifold 400 described in relation to FIG. 7. In the illustrated embodiment of FIG. 8, the series flow manifold 500 may be configured to permit a fluid to flow through the flow manifold 500 in a sequential flow path F, where the fluid flows through each of the filtration devices 300(1)-300(8) in series or successively. As illustrated in FIG. 8, the first and eighth filtration devices 300(1), 300(8) are coupled to only one other filtration device (the second and seventh filtration devices 300(2), 300(7), respectively), while the other filtration devices 300(2)-300(7) are each connected to two filtration devices 300(1)-300(8) (i.e., the respective preceding filtration device 300(1)-300(6) and the respective successive filtration device 300(3)-300(8)) like that explained previously with respect to the parallel flow manifold 400.

However, unlike the parallel flow manifold 400, the valves 340(1)-340(8) of the modular connections 320(1)-320(8) have been rotated or set such that the flow B of a fluid through the series flow manifold 500 flows through the filtration devices 300(1)-300(8) in series or in a successive manner. More specifically, the valves 340(1), 340(3), 340(5), 340(7) of the upper modular connections 320(1), 320(3), 320(5), 320(7) may be rotated or set such that a fluid can flow through the first ends 332(1), 332(3), 332(5), 332(7) and the second ends 334(1), 334(3), 334(5), 334(7) of the T-junction 330(1), 330(3), 330(5), 330(7) of the upper modular connections 320(1), 320(3), 320(5), 320(7), but not the third ends 336(1), 336(3), 336(5), 336(7) of the T-junction 330(1), 330(3), 330(5), 330(7) of the upper modular connections 320(1), 320(3), 320(5), 320(7). In other words, the upper modular connections 320(1), 320(3), 320(5), 320(7) may be set to the fourth operational state D as illustrated in FIG. 5E. In addition, the valves 340(1), 340(3), 340(5), 340(7) of the lower modular connections 320(1), 320(3), 320(5), 320(7) may be rotated or set such that a fluid can flow through the first ends 332(1), 332(3), 332(5), 332(7) and the third ends 336(1), 336(3), 336(5), 336(7) of the T-junction 330(1), 330(3), 330(5), 330(7) of the lower modular connections 320(1), 320(3), 320(5), 320(7), but not the second ends 334(1), 334(3), 334(5), 334(7) of the T-junction 330(1), 330(3), 330(5), 330(7) of the lower modular connections 320(1), 320(3), 320(5), 320(7). In other words, the lower modular connections 320(1), 320(3), 320(5), 320(7) may be set to the first operational state A as illustrated in FIG. 5B. Furthermore, the valves 340(2), 340(4), 340(6), 340(8) of the upper modular connections 320(2), 320(4), 320(6), 320(8) may be rotated or set such that a fluid can flow through the first ends 332(2), 332(4), 332(6), 332(8) and the third ends 336(2), 336(4), 336(6), 336(8) of the T-junction 330(2), 330(4), 330(6), 330(8) of the upper modular connections 320(2), 320(4), 320(6), 320(8), but not the second ends 334(2), 334(4), 334(6), 334(8) of the T-junction 330(2), 330(4), 330(6), 330(8) of the upper modular connections 320(2), 320(4), 320(6), 320(8). In other words, the upper modular connections 320(2), 320(4), 320(6), 320(8) may also be set to the first operational state A as illustrated in FIG. 5B. Additionally, the valves 340(2), 340(4), 340(6), 340(8) of the lower modular connections 320(2), 320(4), 320(6), 320(8) may be rotated or set such that a fluid can flow through the first ends 332(2), 332(4), 332(6), 332(8) and the second ends 334(2), 334(4), 334(6), 334(8) of the T-junction 330(2), 330(4), 330(6), 330(8) of the lower modular connections 320(2), 320(4), 320(6), 320(8), but not the third ends 336(2), 336(4), 336(6), 336(8) of the T-junction 330(2), 330(4), 330(6), 330(8) of the lower modular connections 320(2), 320(4), 320(6), 320(8). In other words, the lower modular connections 320(2), 320(4), 320(6), 320(8) may also be set to the fourth operational state D as illustrated in FIG. 5E. In the series flow manifold 500 depicted in FIG. 8, the second end 334(1) of the T-junction 330(1) of the upper modular connection 320(1) may serve as the inlet 510 of the series flow manifold 500, while the third end 336(8) of the T-junction 330(1) of the upper modular connection 320(8) may serve as the outlet 520 of the series flow manifold 500.

The filtration device 200, 300 depicted in FIGS. 3 and 4, respectively, may be utilized to create customizable manifolds like the parallel flow manifold 400 depicted in FIG. 7 and the series flow manifold 500 depicted in FIG. 8. These customizable flow manifolds 400, 500 may be sized when setting up of the filtration devices 200, 300 for filtration processes instead of making or developing a predetermined flow manifold that is a separate standalone unit from the filtration devices 200, 300. Incorporating the modular connections 230, 320 into the filtration devices 200, 300, respectively, allows for various combinations of filtration devices 200, 300 to be easily paired or coupled together when setting up a process assembly or flow manifold. The twistable/rotatable T-junctions 250, 330 of the filtration devices 200, 300, respectively, (possibly by the incorporation of a rotatable hose barb 370) allows for the modular connections 230, 320 of the filtration devices 200, 300, respectively, to be rotated in either direction. This provides flexibility to set up either a parallel flow manifold 400 (i.e., a U-type or Z-type manifold configuration) or a series flow manifold 500. As previously explained, the dripless disconnects 276, 350 of the filtration devices 200, 300, respectively, allow for each filtration device 200, 300 to be completely self-containing when disassembling filtration devices 200, 300 from a flow manifold 400, 500. Also as previously explained, the sterile connectors 280, 360 ensure each filtration devices 200, 300, respectively, stays sterile when combining the filtration devices 200, 300 into a flow manifold 400, 500. In some embodiments, the modular connectors 230, 320 may be a molded component configured to combine the sterile connectors 280, 360, the dripless disconnect 276, 350, and the T-junctions 250, 330 of the filtration devices 200, 300, respectively, which reduces the footprint of the layout of the flow manifold 400, 500. Thus, utilizing the modular connections 230, 320 ultimately results in a more compact flow manifold 400, 500 than that of traditional manifolds.

In addition, and as previously explained, the valves 260, 340 of the modular connections 230, 320 of the filtration devices 200, 300 enable a user to quickly switch a manifold from being a parallel flow manifold 400, like that illustrated in FIG. 7, to a series flow manifold 500, like that illustrated in FIG. 8 by independently reconfiguring each modular connection 230, 320 to a desired operational state A, B, C, or D. Thus, a user may flow a non-plugging or flushing feed stream through the series flow manifold 500 in order to flush the filtration devices 200, 300, and then actuate the valves 260, 340 of the modular connections 230, 320, respectively, to change the flow manifold from a series flow manifold 500 to a parallel flow manifold 400 (by changing the operational state of one or more modular connections 230, 320) for a plugging or fouling feed stream to be filtered in parallel by the filtration devices 200, 300. Running a non-plugging or flushing feed stream through the filtration devices 200, 300 in series may be well suited to high permeability filtration devices 200, 300 where flow uniformity during flushing can be problematic. Running the flushing feed stream through the series flow manifold 500 configuration may also reduce the total volume of clean water required for flushing the set of filtration devices 200, 300. As previously explained, after the flushing of the filtration devices 200, 300 is completed, the valves 260, 340 of the modular connections 230, 320 may be actuated to change the operational states of one or more of the modular connections 230, 320 in order to reconfigure the series flow manifold 500 into the parallel flow manifold 400 for parallel processing/filtration of a fouling feed stream.

The terms “left,” “right,” “lower,” and “upper” as recited above are merely for descriptive purposes of the arrangement shown in FIG. 8, and that the filtration devices 300(1)-300(8) and the modular connections 320(1)-320(8) may be disposed or arranged in any way such that the modular connections 320(1)-320(8) may be located on any side of the filtration devices 300(1)-300(8) and may be disposed with any physical spatial relation to the filtration devices 300(1)-300(8). Moreover, the number of filtration devices 300(1)-300(8) shown and depicted in FIG. 8 is for illustrative purposes only, and the modular connections 320(1)-320(2) enable any number N of filtration devices 300(1)-300(N) to be coupled to one another for form a flow manifold.

While the apparatuses presented herein have been illustrated and described in detail and with reference to specific embodiments thereof, it is nevertheless not intended to be limited to the details shown, since it will be apparent that various modifications and structural changes may be made therein (e.g., various different types of filtration devices, different shaped “junctions” of the modular connectors, etc.) without departing from the scope of the inventions and within the scope and range of equivalents of the claims.

In addition, various features from one of the embodiments may be incorporated into another of the embodiments. That is, it is believed that the disclosure set forth above encompasses multiple distinct inventions with independent utility. While each of these inventions has been disclosed in a preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions, and/or properties disclosed herein. Accordingly, it is appropriate that the appended claims be construed broadly and in a manner consistent with the scope of the disclosure as set forth in the following claims.

It is also to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention. Additionally, it is also to be understood that the components of the apparatuses described herein, the modular connectors, flow manifolds, and filtration devices described herein, or portions thereof may be fabricated from any suitable material or combination of materials, such as, but not limited to, plastic or metals (e.g., copper, bronze, aluminum, steel, etc.), as well as derivatives thereof, and combinations thereof. In addition, it is further to be understood that the steps of the methods described herein may be performed in any order or in any suitable manner.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Similarly, where any description recites “a” or “a first” element or the equivalent thereof, such disclosure should be understood to include incorporation of one or more such elements, neither requiring nor excluding two or more such elements. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about,” “around,” “generally,” and “substantially.”

What is claimed is:

1. A filtration device comprising:
a housing defining an interior;
a filter media disposed within the interior of the housing;
a plurality of ports disposed on the housing and configured to facilitate a flow of a fluid into and out of the housing; and
a modular connector coupled to each of the plurality of ports, the modular connector including:
a first connector end; and
a second connector end, wherein the first connector end of the modular connector of each of the plurality of ports of the filtration device is configured to be coupled to a second connector end of a modular connector of each of a plurality of ports of a secondary filtration device and the second connector end of the modular connector of each of the plurality of ports of the filtration device is configured to be coupled to a first connector of a tertiary filtration device to facilitate assembly of a modular flow manifold for the filtration device.

2. The filtration device of claim 1, wherein the modular connector further comprises:
a T-junction having a first end, a second end, and a third end, the first end of the T-junction serving as the first connector end of the modular connector, the second end of the T-junction serving as the second connector end of the modular connector, and the third end of the T-junction being coupled to one port of the plurality of ports of the filtration device.

3. The filtration device of claim 2, wherein the modular connector further comprises:
a valve operatively coupled to the T-junction and configured to selectively open and close each of the first end, the second end, and the third end of the T-junction.

4. The filtration device of claim 3, wherein the modular flow manifold can operate with both a parallel flow path, where the flow of the fluid flows through the filtration device, the secondary filtration device, and the tertiary filtration device in parallel, and a series flow path, where the flow of the fluid flows through the filtration device, the secondary filtration device, and the tertiary filtration device in series, depending on a setting of the valve.

5. The filtration device of claim 2, wherein, when coupled to the filtration device, at least a portion of the T-junction is configured to rotate about an axis passing through the third end of the T-junction.

6. The filtration device of claim 2, wherein the modular connector further comprises:
a dripless disconnect disposed within the T-junction proximate to the second end of the T-junction.

7. The filtration device of claim 1, wherein the modular connector further comprises:
a first sterile connector disposed on the first connector end; and
a second sterile connector disposed on the second connector end.

8. The filtration device of claim 1, wherein the plurality of ports includes at least an inlet port, an outlet port, and a vent port.

9. A method of assembling and operating a modular flow manifold, the method comprising:
equipping a plurality of ports of a plurality of filtration devices with modular connectors, each modular connector comprising a first connector end and a second connector end;
coupling a first filtration device of the plurality of filtration devices with a second filtration device of the plurality of filtration devices by coupling the second connector ends of the modular connectors of the first filtration device to the first connector ends of the modular connectors of the second filtration device; and
setting a valve of each of the modular connectors to facilitate a parallel flow through the modular flow manifold where a fluid flows simultaneously through the first and second filtration devices.

10. The method of claim 9, wherein the first ends of the modular connectors of the first filtration device serve as an inlet and an outlet of the modular flow manifold.

11. The method of claim 10, wherein the valves of the modular connectors of the second filtration device are set such that the fluid cannot flow through the second ends of modular connectors of the second filtration device.

12. The method of claim 9, further comprising:
coupling a third filtration device to the second filtration device by coupling the first connector ends of the modular connectors of the third filtration device to the second connector ends of the modular connectors of the second filtration device.

13. The method of claim 9, wherein the fluid is a second fluid, and further comprising, prior to setting the valve of each of the modular connectors to the parallel flow:
setting the valve of each of the modular connectors to facilitate a series flow through the modular flow manifold where a first fluid flows first through the first filtration device and then through the second filtration device.

14. The method of claim 13, wherein the first fluid is a flushing feed stream.

15. The method of claim 14, wherein the second fluid is a fouling feed stream.

16. A modular connector for a filtration device, comprising:
a T-junction having a first end, a second end, and a third end, the third end being attached to a port of the filtration device;
a valve disposed in the T-junction and configured to selectively and independently open and close the first end, the second end, and the third end of the T-junction;
a first sterile connector coupled to the first end of the T-junction; and
a second sterile connector coupled to the second end of the T-junction, wherein the first sterile connector is configured to be coupled to a second sterile connector of a second modular connector and the second sterile connector is configured to be coupled to a first sterile connector of a third modular connector.

17. The modular connector of claim 16, wherein, when attached to the filtration device, at least a portion of the T-junction is configured to rotate about an axis passing through the third end of the T-junction.

18. The modular connector of claim 16, further comprising:
a dripless disconnect disposed proximate to the second end of the T-junction.

19. The modular connector of claim 16, further comprising:
a first conduit having a first end and an opposite second end, the first end being directly coupled to the port of the filtration device and the second end being directly coupled to the third end of the T-junction.

20. The modular connector of claim 19, further comprising:
a second conduit having a first end and an opposite second end, the first end of the second conduit being directly coupled to the second end of the T-junction and the second end of the second conduit being directly coupled to the second sterile connector.
